(19) United States
(12) Patent Application Publication
(10) Pub. No.: US 2020/0044939 A1
(43) Pub. Date: Feb. 6, 2020

(54) INTERACTIVE SYSTEM FOR VISUALIZING AND MAINTAINING LARGE NETWORKS

(71) Applicant: Futurewei Technologies, Inc., Plano, TX (US)

(72) Inventor: Yinglong Xia, San Jose, CA (US)

(21) Appl. No.: 16/052,216

(22) Filed: Aug. 1, 2018

(51) Int. Cl. H04L 12/24; G06F 17/30; G06F 9/52; H04L 12/26; G06T 11/20; G06F 3/0484

(52) U.S. Cl. CPC H04L 41/22; G06F 17/30572; G06F 17/30958; G06F 17/30377; G06T 2200/24; H04L 43/045; G06T 11/206; G06F 3/04847; G06T 2210/52; G06F 9/52

(57) ABSTRACT

A network graph analysis tool identifies clusters of nodes in a network graph based on edges connecting the nodes. It then distributes the clusters of nodes in a two-dimensional plane to generate a two-dimensional representation of a network. For each cluster, the tool distributes the nodes in the cluster in the two-dimensional plane to calculate respective coordinates of the nodes in the cluster. The result is a two-dimensional mapped network graph of the cluster. The tool then generates a density map of the network based on the calculated coordinates of the nodes in the mapped network graph, and in response to a selection of a sub-area of the density map, provides, for display, selected nodes and edges in the mapped network graph having coordinates corresponding to the selected sub-area of the density map. The selected nodes and edges may be magnified in response to a software visualization lens.

### TECHNICAL FIELD

The present disclosure is related to tools for analyzing and managing networks, and in particular to a tool for imaging sub-graphs of a network graph stored in a graph database in near-real time as the graph database is updated.

### BACKGROUND

Graph databases have supplanted traditional relational databases in many areas due to their relative ease of use. For example, graph databases are currently being used for social network data mining, computer network monitoring, fraud detection, artificial intelligence (AI) engines, and data management.

A graph database defines a network having a plurality of nodes, also called vertices, where each node is connected to other nodes in the network by one or more edges. A network node may be represented by a row in an array where columns of the array may represent respective edges that connect the node to other nodes in the network. Other dimensions of the array may hold parameters that further define the node. For example, in a social network application, the parameters of the node may include an identification parameter that identifies the node or a user of the node, a picture of the user, and parameters from the user's profile. The edges defined for the node may include links to other users who have been identified as friends of the user in the social network.

### SUMMARY

According to an aspect, an apparatus includes a graph database including network graph data describing a network, a memory including program instructions, and processing circuitry coupled to the memory. The program instructions configure the processing circuitry to identify clusters of nodes in the network graph data based on edges connecting the nodes and distribute the clusters of nodes in a two-dimensional plane to generate a two-dimensional representation of the network. For each cluster, the program instructions configure the processing circuitry to distribute the nodes in the cluster in the two-dimensional plane and calculate respective coordinates of the nodes in the cluster to generate a two-dimensional map of the cluster. The calculated coordinates of the nodes are stored in the network graph to generate a mapped network graph. The program instructions further configure the processing circuitry to generate a density map representation of the network based on the calculated coordinates of the nodes in the mapped network graph, and in response to a selection of a sub-area of the density map representation, provide, for display, selected nodes and the edges connecting the selected nodes in the mapped network graph having coordinates corresponding to the selected sub-area of the density map representation. The clustering and spreading of the clusters and the spreading of the nodes in each cluster allow easier visualization of the network graph in the graph database and, thus, ease analysis, maintenance, and management of the network.

Optionally, in the preceding aspect, a further implementation of the aspect includes program instructions that configure the processing circuitry to provide the selected nodes and edges from the mapped network graph as a magnified image representing a magnification of the selected sub-area of the density map representation.

Optionally, in any preceding aspect, a further implementation of the aspect includes program instructions that further configure the processing circuitry to provide the density map representation to a user device, receive, as the selected sub-area of the density map representation, a selected coordinate location in the density map representation, and determine the selected nodes and edges to be displayed based on the selected coordinate location.

Optionally, in any preceding aspect, a further implementation of the aspect includes program instructions that further configure the processing circuitry to receive a lens shape parameter and a lens size parameter, determine the selected nodes and edges to be displayed based on the selected coordinate location and the lens size parameter, and determine a layout of the selected nodes and edges based on the lens shape parameter.

Optionally, in any preceding aspect, a further implementation of the aspect includes program instructions that configure the processing circuitry to assign force-directed graph distribution parameters to each cluster and to each edge connecting the cluster to another one of the clusters, and to apply force-directed graph distribution to the clusters to define respective coordinate positions of respective centroids for the clusters in the two-dimensional plane.

Optionally, in any preceding aspect, a further implementation of the aspect includes program instructions that configure the processing circuitry to determine an updated centroid for each cluster based on the calculated coordinates of the nodes in the cluster and update the coordinates of the nodes in the cluster in response to the updated centroid for the cluster.

Optionally, in any preceding aspect, a further implementation of the aspect includes program instructions that cause the processing circuitry to implement a plurality of parallel processing threads and calculate the coordinates of the nodes in each of the clusters using a respectively different parallel processing thread.

Optionally, in any preceding aspect, a further implementation of the aspect includes program instructions that cause the processing circuitry implementing each of the parallel processing threads to assign force-directed graph parameters to each node and each edge in the cluster, and to apply force-directed graphing to the nodes and edges in the cluster to define a layout of the nodes in the cluster in the two-dimensional plane.

According to another aspect, a method that uses processing circuitry to analyze a network graph in a graph database includes identifying clusters of nodes in the network graph based on edges connecting the nodes and distributing the clusters of nodes in a two-dimensional plane to generate a two-dimensional representation of a network. The method further includes, for each cluster, calculating respective coordinates of the nodes in the cluster to generate a two-dimensional map of the cluster and storing the calculated coordinates in the network graph to generate a mapped network graph. The method also includes generating a density map representation of the network based on the calculated coordinates of the nodes in the mapped network graph and, in response to a selection of a sub-area of the density map representation, providing for display selected nodes and the edges connecting the selected nodes in the mapped network graph, the selected nodes having coordinates in the mapped network graph corresponding to the selected sub-area of the density map representation.

Optionally, in any preceding aspect, providing the selected nodes for display includes providing the selected nodes and edges from the mapped network graph as a magnified image representing a magnification of the selected sub-area of the density map representation.

Optionally, in any preceding aspect, a further implementation of the aspect includes providing the density map representation to a user device, receiving, as the selected sub-area of the density map representation, a selected coordinate location in the density map representation, and determining the selected nodes and edges to be displayed based on the selected coordinate location.

Optionally, in any preceding aspect, a further implementation of the aspect includes receiving a lens shape parameter and a lens size parameter, determining the selected nodes and edges to be displayed based on the selected coordinate location and the lens size parameter, and determining a layout of the selected nodes and edges based on the lens shape parameter.

Optionally, in any preceding aspect, a further implementation of the aspect includes assigning force-directed graph distribution parameters to each cluster and to each edge connecting the cluster to another one of the clusters, and applying force-directed graph distribution to the clusters to define respective coordinate positions of respective centroids for the clusters in the two-dimensional plane.

Optionally, in any preceding aspect, a further implementation of the aspect includes determining an updated centroid for each cluster based on the calculated coordinates of the nodes in the cluster and updating the coordinates of the nodes in the cluster in response to the updated centroid for the cluster.

Optionally, in any preceding aspect, a further implementation of the aspect includes implementing a plurality of parallel processing threads and calculating the coordinates of the nodes in each of the clusters using a respectively different processing thread.

Optionally, in any preceding aspect, a further implementation of the aspect includes, when calculating the coordinates of the nodes of a respective cluster using a respectively different processing thread, assigning force-directed graph parameters to each node and each edge in the cluster and applying force-directed graphing to the nodes and edges in the cluster to define a layout of the nodes in the cluster in the two-dimensional plane.

According to yet another aspect, an apparatus using processing circuitry to analyze a network graph in a graph database includes means for identifying clusters of nodes in the network graph based on edges connecting the nodes and means for distributing the clusters of nodes in a two-dimensional plane to generate a two-dimensional representation of a network. The apparatus further includes, for each cluster, means for calculating respective coordinates of the nodes in the cluster to generate a two-dimensional map of the cluster and means for storing the calculated coordinates in the network graph to generate a mapped network graph. The apparatus also includes means for generating a density map representation of the network based on the calculated coordinates of the nodes in the mapped network graph and means, in response to a selection of a sub-area of the density map representation, for providing for display selected nodes and the edges connecting the selected nodes in the mapped network graph, the selected nodes having coordinates in the mapped network graph corresponding to the selected sub-area of the density map representation.

Optionally, in any preceding aspect, a further implementation of the aspect includes means for providing the selected nodes and edges from the mapped network graph as a magnified image representing a magnification of the selected sub-area of the density map representation.

Optionally, in any preceding aspect, a further implementation of the aspect includes means for providing the density map representation to a user device, means for receiving, as the selected sub-area of the density map representation, a selected coordinate location in the density map representation, and means for determining the selected nodes and edges to be displayed based on the selected coordinate location.

Optionally, in any preceding aspect, a further implementation of the aspect includes means for receiving a lens shape parameter and a lens size parameter, means for determining the selected nodes and edges to be displayed based on the selected coordinate location and the lens size parameter, and means for determining a layout of the selected nodes and edges based on the lens shape parameter.

Optionally, in any preceding aspect, a further implementation of the aspect includes means for assigning force-directed graph distribution parameters to each cluster and to each edge connecting the cluster to another one of the clusters, and means for applying force-directed graph distribution to the clusters to define respective coordinate positions of respective centroids for the clusters in the two-dimensional plane.

Optionally, in any preceding aspect, a further implementation of the aspect includes means for determining an updated centroid for each cluster based on the calculated coordinates of the nodes in the cluster and means for updating the coordinates of the nodes in the cluster in response to the updated centroid for the cluster.

Optionally, in any preceding aspect, a further implementation of the aspect includes means for implementing a plurality of parallel processing threads and means for calculating the coordinates of the nodes in each of the clusters using a respectively different processing thread.

Optionally, in any preceding aspect, the means for calculating the coordinates of the nodes in each of the clusters using a respectively different processing thread includes means for assigning force-directed graph parameters to each node and each edge in the cluster and means for applying force-directed graphing to the nodes and edges in the cluster to define a layout of the nodes in the cluster in the two-dimensional plane.

According to another aspect, a computer-readable medium includes instructions used by processing circuitry to analyze a network graph in a graph database, the instructions, when executed by the processing circuitry, configuring the processing circuitry to identify clusters of nodes in the network graph based on edges connecting the nodes and distribute the clusters of nodes in a two-dimensional plane to generate a two-dimensional representation of a network. The instructions also configure the processing circuitry to, for each cluster, calculate respective coordinates of the nodes in the cluster to generate a two-dimensional map of the cluster, store the calculated coordinates in the network graph to generate a mapped network graph, and generate a density map representation of the network based on the calculated coordinates of the nodes in the mapped network graph. Furthermore, the instructions configure the processing circuitry, in response to a selection of a sub-area of the density map representation, to provide for display selected nodes and the edges connecting the selected nodes in the mapped network graph, the selected nodes having coordinates in the mapped network graph corresponding to the selected sub-area of the density map representation.

Optionally, in any preceding aspect, a further implementation of the aspect includes instructions that configure the processing circuitry to provide the selected nodes and edges from the mapped network graph as a magnified image representing a magnification of the selected sub-area of the density map representation.

Optionally, in any preceding aspect, a further implementation of the aspect includes instructions that configure the processing circuitry to provide the density map representation to a user device, receive, as the selected sub-area of the density map representation, a selected coordinate location in the density map representation, and determine the selected nodes and edges to be displayed based on the selected coordinate location.

Optionally, in any preceding aspect, a further implementation of the aspect includes instructions that configure the processing circuitry to receive a lens shape parameter and a lens size parameter, determine the selected nodes and edges to be displayed based on the selected coordinate location and the lens size parameter, and determine a layout of the selected nodes and edges based on the lens shape parameter.

Optionally, in any preceding aspect, a further implementation of the aspect includes instructions that configure the processing circuitry to assign force-directed graph distribution parameters to each cluster and to each edge connecting the cluster to another one of the clusters, and apply force-directed graph distribution to the clusters to define respective coordinate positions of respective centroids for the clusters in the two-dimensional plane.

Optionally, in any preceding aspect, a further implementation of the aspect includes instructions that cause the processing circuitry to determine an updated centroid for each cluster based on the calculated coordinates of the nodes in the cluster and update the coordinates of the nodes in the cluster in response to the updated centroid for the cluster.

Optionally, in any preceding aspect, a further implementation of the aspect includes instructions that cause the processing circuitry to implement a plurality of parallel processing threads and calculate the coordinates of the nodes in each of the clusters using a respectively different processing thread.

Optionally, in any preceding aspect, a further implementation of the aspect includes instructions that cause the processing circuitry to assign force-directed graph parameters to each node and each edge in the cluster and apply force-directed graphing to the nodes and edges in the cluster to define a layout of the nodes in the cluster in the two-dimensional plane.

Any one of the foregoing examples may be combined with any one or more of the other foregoing examples to create a new embodiment within the scope of the present disclosure.

### BRIEF DESCRIPTION OF THE DRAWINGS

FIG. 1A is a screen shot showing an example of a visualization of a very large network graph.

FIG. 1B is a screen shot showing an output image produced by an example hybrid network graph visualization tool according to example embodiments.

FIG. 2 is a functional block diagram of an example hybrid graph visualization system.

FIG. 3 is a flow-chart diagram of a back-end process that is configured to run on a network-connected service.

FIG. 4 is a flow-chart diagram showing an example front-end process used to visualize sub-graphs of a network graph in a graph database.

FIGS. 5A, 5B, 5C, and 5D are perspective diagrams that are useful for describing the operation of a visualization lens.

FIG. 6 is a block diagram of an example processing system that may be used in example embodiments.

### DETAILED DESCRIPTION

In the following description, reference is made to the accompanying drawings that form a part hereof, and in which are shown by way of illustration specific embodiments which may be practiced. These embodiments are described in sufficient detail to enable those skilled in the art to practice the subject matter described below, and it is to be understood that other embodiments may be utilized and that structural, logical, and electrical changes may be made consistent with the present description. The following description of example embodiments is, therefore, not to be taken in a limited sense, and the scope of the described subject matter is defined by the appended claims.

As used herein, the term “network” refers to any collection of nodes connected by edges. Graph databases for large networks may themselves be very large. A social networking service may have over two billion users, where some users have millions of friends/followers. The graph database for this network may have a row (node) for each user and a link (edge) for each friend/follower. In another example, a graph database of information technology (IT) assets of an enterprise may have hundreds of thousands of nodes and edges. In yet another example, a graph used in a public safety scenario may have on the order of ten billion nodes and 100 billion edges.

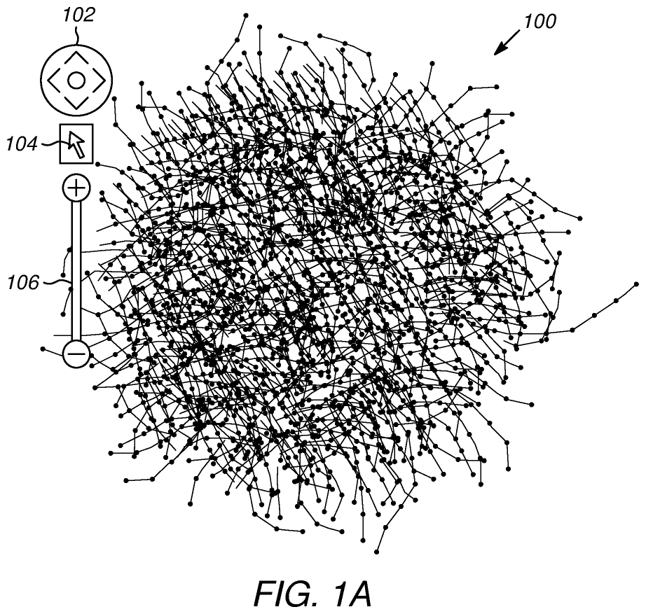

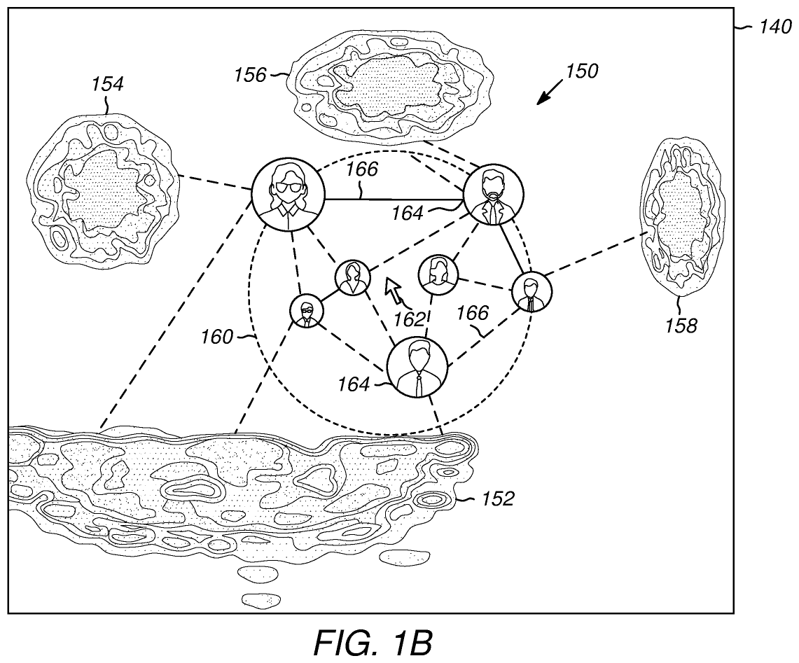

FIG. 1A is a screen shot showing an example of a visualization of a large network graph 100. FIG. 1A also shows an image positioning control 102, a cursor 104, and an image magnifying control 106. The image positioning control 102 may be used to scroll over the image of the network graph 100 to select a portion of the network graph 100 to be displayed, in this example, the entire network graph 100. The cursor 104 may be used to select a particular location on the network graph 100, and the image magnifying control 106 may be used to control the magnification of the image of the network graph 100 at the selected location (e.g., zooming in or zooming out). For example, a user may employ the image positioning control to scroll over the graph, at a given magnification level, in any of the cardinal directions by selecting the appropriate arrow, using a pointing device, and holding a pointing device as the image is scrolled. Once a desired portion is in view, the user may then use the cursor 104 to select a particular location on the current image. The magnifying control 106 may then be used to magnify the graph centered at the selected location. The user interface shown in FIG. 1A may be useful for visualizing relatively small graphs; it may not be useful, however, for visualizing large graphs, such as the network graph 100 shown in FIG. 1A. This is because the size of the display is too small to meaningfully capture the scope of the network graph 100. For example, a 4K monitor displays 2160 lines with 3840 pixels on each line, and an 8K monitor displays 4320 lines with 7680 pixels on each line. The number of pixels is less than the number of nodes in even a moderately-sized network graph.

Furthermore, it may be impractical to process the large amount of data in a very large network graph on a typical workstation computer, such as a laptop. While it may be possible to visualize a representation of portions of the network graph offline (e.g., based on a snapshot of the database), such processing may still use formidable resources. It would be advantageous to be able to visualize such a very large network graph on a workstation in real time or almost in real time.

FIG. 1B is a screen shot showing an output image produced by an example hybrid network graph visualization tool according to an embodiment. The hybrid network graph visualization tool is better suited for analyzing large networks than the tool shown in FIG. 1A because, as described below, the tool shown in FIG. 1B clusters the nodes, distributes the clusters and also distributes the nodes in each cluster. FIG. 1B shows a visualization of a very large network graph 150, such as the graph shown in FIG. 1A, on a monitor screen 140. The nodes and edges of the network graph 150 are distributed around the monitor screen 140 because they have been clustered and mapped onto a two-dimensional plane (e.g., an X-Y plane) such that different clusters 152, 154, 156, and 158 are displayed on different parts of the monitor screen 140 with an indication of their densities. For example, the clusters may be displayed as a heat map in which hotter areas (e.g., red and yellow) represent denser concentrations of nodes and cooler areas (e.g., green, blue, and violet) represent sparser concentrations of nodes. In FIG. 1B, the different shadings represent different colors with the warmer colors toward the center of the clusters and the cooler colors toward the edges of the clusters.

As described below, a selected portion of the network graph 150 may be visualized using a software visualization lens 160. A user may specify a size and shape of the visualization lens 160 and an area of the network graph 150 to be magnified. Furthermore, a user may move the visualization lens 160 to different portions of the network graph 150 by moving a cursor 162 at the center of the visualization lens 160. Nodes 164 and edges 166 in the portion of the network graph 150 centered on the cursor 162 position and spanning the specified size of the area to be magnified by the visualization lens 160 are shown in greater detail. As shown in FIG. 1B, each node 164 may include data (e.g., a picture) identifying the node 164 and edges 166 showing connections among the nodes 164. The amount of data displayed for each node may depend on the size of the magnified nodes and/or the density of the area being magnified, and may vary with different magnification factors and/or node densities.

Example embodiments described below allow visualization of a very large graph database of a network almost in real time to aid in the management and maintenance of the network. The embodiments partition the processing of the database between a network-connected (e.g., cloud) service configured for parallel processing and a local workstation configured to provide a selection of a portion of the graph to view and to display the results. The example hybrid visualization tool provides several advantages for viewing very large databases. In particular, the clustering of the database allows a user to quickly identify associated groups of nodes. The distribution of the clusters on the two-dimensional plane separates the data into more manageable data sets, and the density map representation allows a user to quickly identify dense and sparse segments of the database.

The visualization lens 160 further allows a user to investigate a small portion of the network graph almost in real time, for example, to investigate specific nodes and their connectivity to other nodes as well as to investigate connections among the clusters of nodes. Because the shape (e.g., magnification factor) and size (e.g., area of the network graph to be magnified) of the lens may be varied, users may visualize portions of the network graph at different hierarchical levels and may navigate around the network graph following the edge connections among the nodes. This may be particularly useful to identify anomalies in the underlying network. Furthermore, because the information is available almost in real time, the effects of changes to the database may be visualized soon after they are made, without the need to take a snapshot of the database and analyze the snapshot offline.

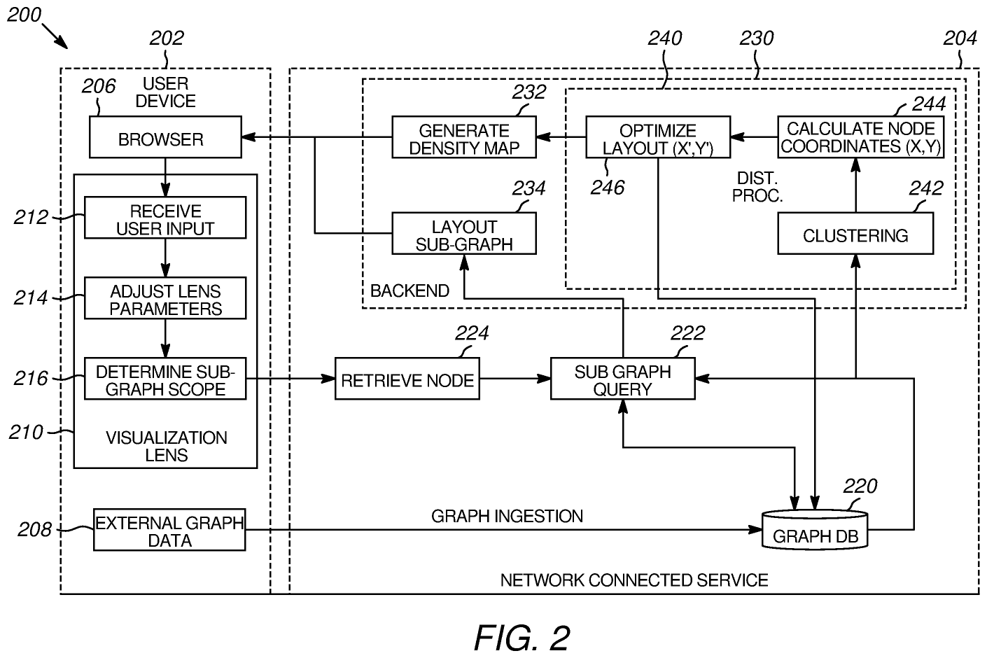

FIG. 2 is a functional block diagram of an example hybrid graph visualization system 200 according to the present disclosure. The example system includes a workstation, such as a user device 202, and a network-connected service 204. The network-connected (e.g., cloud) service 204 may be implemented in one or more servers accessible to the user device 202 via a network (not shown). For example, the network-connected service 204 may be a web application accessed via the Internet using a browser 206 running on the user device 202. The network connected service includes backend processing 230 that process the network graph data stored in the graph database server 220 and modules 224 and 222 that access the network graph data in the graph database as requested by the user device 202 for display on the user device 202.

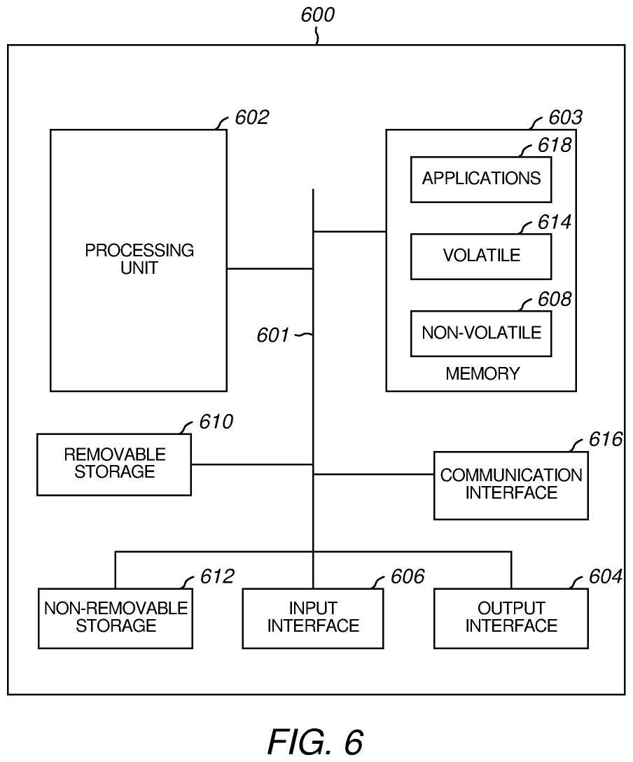

The user device 202 includes a browser 206, a visualization lens 210, and a memory 208 defining the graph to be analyzed. The browser 206 and visualization lens 210 may be implemented in software running on a processing system, such as the system shown in FIG. 6 which also includes the memory 208. The network connected service 204 includes backend processing 230 which includes a distributed processing component 240. The network-connected service includes a graph database server 220 and one or more processing elements that implement back-end functions for the visualization tool. These functions include a clustering function 242, a coordinate calculation function 244, a layout optimization function 246, a density map generation function 232, a retrieve node function 224, a sub-graph query function 222 and a sub-graph layout function 234.

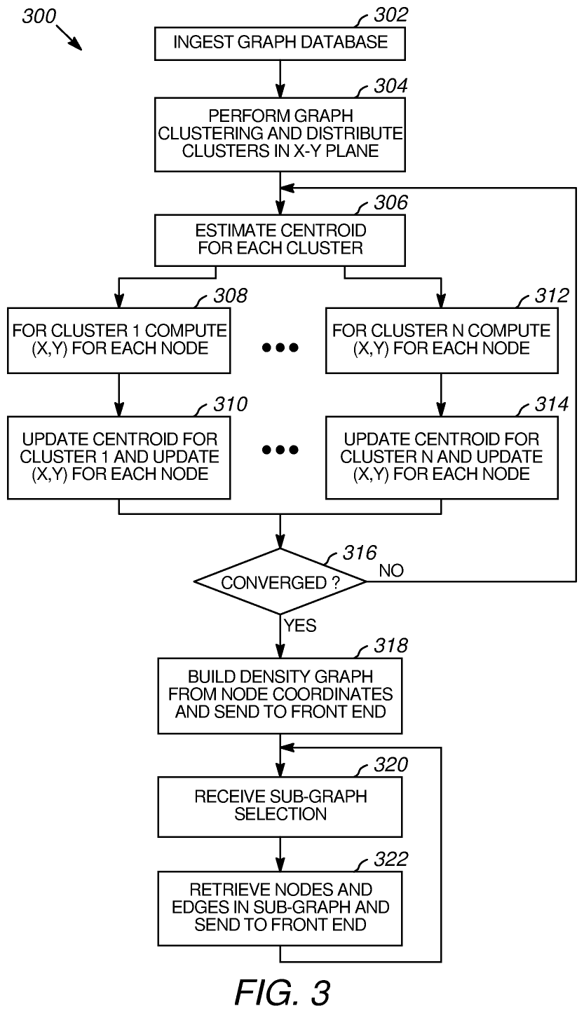

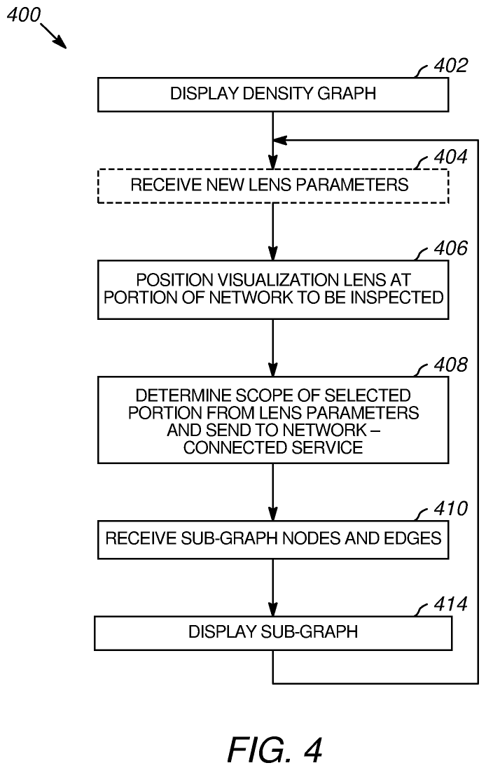

The operation of the embodiment shown in FIG. 2 is described with reference to the flow-charts shown in FIGS. 3 and 4, which illustrate the back-end functions and front-end functions, respectively. FIG. 3 is a flow-chart diagram of a back-end process 300 configured to run on the network-connected service 204. FIG. 3 shows an example process that implements the functions 222, 224, 230, 232, 234, 240, 242, 244, and 246 of FIG. 2. At block 302 of FIG. 3, a function 208 of the user device 202 provides the graph describing the network to a graph database server 220 of the network-connected service 204. As described above, the network graph may be an array having two or more dimensions in which one dimension (e.g., the rows) may correspond to nodes and another dimension (e.g., the columns) may correspond to edges. Other dimensions of the matrix may include parameters of the node. In some embodiments, the graph may be provided as a comma-separated values (CSV) file. The file may be expanded into a network graph which is stored by the graph database server 220.

At block 304, the network-connected service 204 separates the nodes in the database into clusters as indicated by the clustering function 242 of FIG. 2. In some embodiments, the clustering function 242 may implement a clustering algorithm such as K-Means Clustering, Mean-Shift Clustering, Density-Based Spatial Clustering with Application of Noise (DBSCAN), Expectation-Maximization (EM) Clustering using Gaussian Mixture Models (GMM), and/or Agglomerative Hierarchical Clustering. Briefly, clustering algorithms identify groups of nodes that are strongly connected (e.g., have many interconnected edges). These groups of nodes may have fewer connections to nodes in other groups. Each such group is assigned to a cluster.

After the nodes have been assigned to clusters, the network-connected service 204, still in block 304, calculates an approximate layout for the clusters in a global two-dimensional plane. The materials that follow use a force-directed graph distribution algorithm both to distribute clusters and to distribute the nodes in each cluster. It is contemplated, however, that any layout technique that is applicable to a planar graph may be used. Many different layout techniques may be used to distribute the clusters, including spectral layout, which derives coordinates from an adjacency matrix of the network graph; a tree layout algorithm, in which each node is drawn such that the child nodes to which it is connected form a circle surrounding the node and the radius of the circle decreases at lower levels of the tree; and a force-directed graph distribution algorithm, in which a repulsive force is assigned to each cluster and attractive forces are assigned to the edges connecting the clusters. Some embodiments iteratively run the force-directed algorithm, which pushes the clusters away from each other until the repulsive forces of the clusters are balanced by the attractive forces of the edges. Each cluster is treated as a single node having edges that connect to the other clusters. For networks having many clusters, it may be desirable for the repulsive force to be relatively large compared to the attractive force so that the clusters are well spread across the X-Y plane. Once the balance is achieved, the network-connected service 204 estimates a centroid for each cluster, as shown in block 306 of FIG. 3. Initially, the centroid of the cluster may be the coordinates of the modeled node, corresponding to the cluster, in the global two-dimensional plane.

After an initial centroid has been estimated for each cluster, the network-connected service 204 distributes the nodes in each of the clusters in the global two-dimensional plane. As shown in blocks 308, 310, 312, and 314 of FIG. 3, each cluster is then processed separately relative to respective local two-dimensional planes, so that multiple clusters are processed in parallel. The parallel processing is implemented by the distributed processing function 240 shown in FIG. 2. To implement this function, the network-connected service 204 may employ multiple processors, where each processor implements one or more threads. Thus, each thread may be modeled by a process running on a separate virtual machine (VM). While the clustering function 242 is shown as being performed by the distributed processing function 240, it is contemplated that it may be performed by one processing thread of the multiple processing threads. FIG. 3 shows two threads, one processing cluster 1 and one processing cluster N. As indicated in FIG. 3, there may be many threads, each thread processing a separate cluster. Each thread may also implement a distribution algorithm such as a force-directed graph distribution algorithm on the nodes and edges of the cluster assigned to the thread, for example in blocks 308 and 312 of FIG. 3, corresponding to function 244 of FIG. 2. In some embodiments, each thread runs the algorithm in the local two-dimensional plane that is not linked to the global two-dimensional plane corresponding to the cluster centroids.

As described above, force-directed graph distribution is an iterative algorithm. After each iteration, at blocks 310 and 314, if local two-dimensional planes are being used, each thread may map its local two-dimensional plane onto the global two-dimensional plane and determine a displacement of the cluster centroid relative to the previous iteration. Also at blocks 310 and 314, the thread updates the centroid for the cluster by this displacement. Each thread of the process 300 may generate this displacement, for example, by averaging the X and Y coordinates for each node in the cluster being processed to generate a new centroid and by comparing the new centroid to the previously calculated centroid. After updating the coordinates of the centroid for the cluster, blocks 310 and 314 update the X and Y coordinates of each node in the global two-dimensional plane based on the updated centroid. In some embodiments, this may entail adding the local X and Y coordinates of the nodes to the updated X and Y coordinates of the clusters.

At block 316, the process 300 compares the locations of the calculated centroids of all of the clusters to their locations after the previous iteration to determine whether the algorithm has converged. Convergence may be determined, for example, when the largest displacement of any cluster centroid is less than a threshold. It is contemplated, however, that other measurements may be used, such as comparing the mean or median displacement of the cluster centroids to a threshold. When, at block 316, the process 300 determines that the distribution algorithm has not converged, the process 300 transfers control to block 306, which assigns the updated centroids calculated in blocks 310 and 314 as new cluster centroid estimates, and runs another iteration of the algorithm on the multiple threads of the network-connected service 204. Blocks 310, 314, and 316 of FIG. 3 correspond to function 246 of FIG. 2.

When block 316 determines that the layout has converged, it may write the network graph, with X and Y coordinates assigned to each node, back to the graph database server 220 as a mapped network graph that either replaces the original network graph or is stored as a separate mapped network graph. The mapped network graph with the X and Y coordinates is used, as described below, to visualize sub-graphs of the network graph received from the user device 202.

When block 316 determines that the algorithm has converged, block 318, corresponding to function 232 of FIG. 2, generates a density map (e.g., a heat map) over the two-dimensional plane from the node coordinates. The density map may be generated, for example, by dividing the two-dimensional plane into blocks, where each block corresponds to a pixel or group of pixels on the display, and counting the number of nodes in each block. Blocks having larger numbers of nodes are assigned a hotter color (e.g., yellow or red), while blocks having smaller numbers of nodes may be assigned a cooler color (e.g., green, blue, or violet). Blocks having no nodes may not be assigned a color. While the embodiments show the density map being a heat map, it is contemplated that the system may implement other types of density maps, for example, a three-dimensional rendering in which denser areas of the two-dimensional plane appear to have more depth.

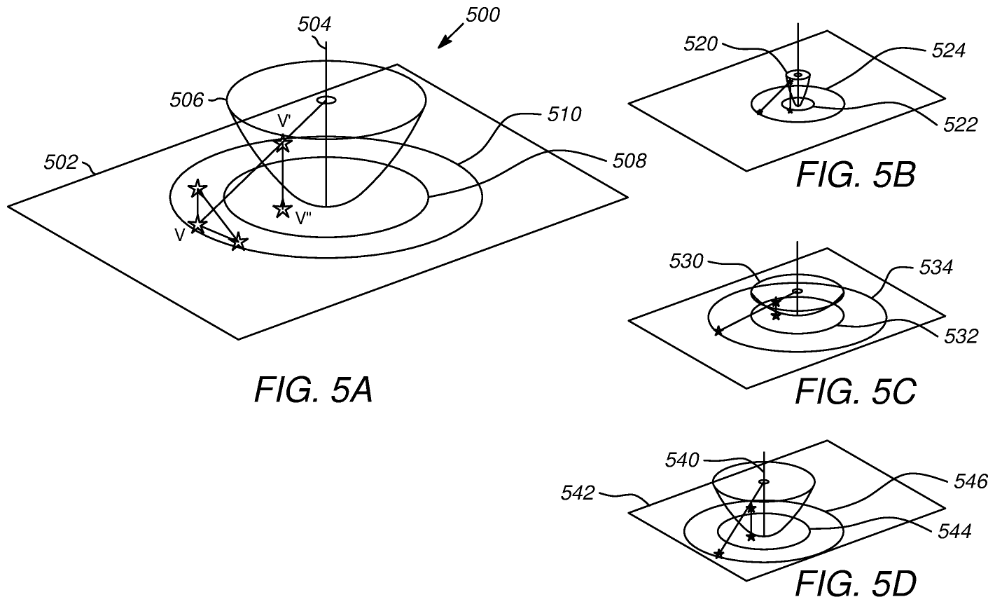

The density map may be sent to the user device 202 by function 232 of FIG. 2 for front-end processing as described below with reference to FIGS. 4-5D. The user device 202 may navigate the visualization lens 160 over the density map to specify a sub-graph to be inspected using the visualization lens 160. When the process 300 receives the specific sub-graph selection at block 320, corresponding to retrieve node function 224 of FIG. 2, it executes block 322, corresponding to function 224 of FIG. 2, to generate a sub-graph query and retrieve the nodes and edges of the sub-graph from the mapped network graph that is stored in the graph database server 220. Block 322 also determines the layout 234 of the sub-graph and sends the sub-graph to the user device 202 for display. The layout 234 may be determined by mapping the (X,Y) coordinates of the nodes of the sub-graph selected from the mapped network graph according to the lens magnification factor. Alternatively, the layout sub-graph module 234 may apply a distribution algorithm, such as a force-directed graph visualization algorithm, to the nodes in the specified sub-graph to generate the sub-graph layout.

When the configuration of the network changes, the back-end system described above with reference to FIGS. 2 and 3 may receive a new copy of the graph database and re-run the process 300 to generate a new mapped network graph. Alternatively, the system may process only the clusters that were modified by re-running blocks 306-316 of the process 300. It is expected that the individual affected clusters may be processed more quickly than the entire network database. Accordingly, the modified mapped network graph may be available shortly after the modifications are provided to the network-connected service 204 (e.g., almost in real time).

FIG. 4 is a flow-chart diagram showing an example front-end process 400 used by the user device 202 to visualize sub-graphs of the mapped network graph. At block 402, the user device 202 receives and displays the density map generated at block 318 of FIG. 3 and function 232 of FIG. 2. The user device 202 optionally, as indicated by the broken lines, receives user input (212), at block 404, specifying or changing parameters of a software visualization lens 210. As described below with reference to FIGS. 5A-5C, the user may adjust the shape (e.g., magnification factor) of the lens and the size of the lens. As shown in FIG. 5D, the user may also adjust the position of the lens on the density map.

At block 404, the user device 202 receives and adjusts the lens parameters (214) to be used to specify a sub-graph to be analyzed. At block 406, the user device 202 receives a selection of a portion of the network to be inspected (e.g., the specified sub-graph) in response to a user positioning a pointing device (e.g., a mouse, touch-screen, trackpad, or trackball) on the density map. At block 408 of FIG. 4 and function 216 of FIG. 2, the user device 202 determines the scope of the specified sub-graph based on the position of the pointing device and the lens parameters. This specification process is described below with reference to FIGS. 5A-5D. The area of the mapped network graph corresponding to the specified sub-graph is passed by the function 216 of the user device 202 to the retrieve node function 224 of the network-connected service 204, described above.

As described above, after block 408, the user device 202 receives, in block 410, the nodes and edges in the specified sub-graph area via the browser 206. These nodes and edges are received in a layout determined by the sub-graph layout function 234 of the network-connected service 204. At block 414, the user device 202 displays the specified sub-graph, for example, as an inset in, or overlay on, the density map. The sub-graph may be displayed in a circular area, as shown for the visualization lens 160 in FIG. 1B.

After displaying the specified sub-graph, the process 400 branches back to block 404 to optionally receive new lens parameters and/or to receive a displacement of the pointing device specifying another sub-graph of the mapped network graph for inspection. For example, after displaying a first specified sub-graph, the user device 202 may receive instructions to increase the magnification factor while reducing the lens diameter and leaving the position of the visualization lens 210 unchanged in order to inspect a smaller sub-graph in greater detail. Alternatively, the user device 202 may receive instructions to move the pointer to another part of the density map in order to view a different sub-graph of the mapped network graph in the graph database server 220 at the same magnification factor as the first sub-graph.

FIGS. 5A, 5B, 5C, and 5D are perspective diagrams that are useful for describing the operation of the visualization lens. FIG. 5A shows an example network visualization 500 including a visualization lens 506. The visualization lens 506 is not a physical object; it is, instead, a software construct that maps (X,Y) coordinates on the density map onto particular nodes and edges of the mapped network graph in the graph database server 220. Furthermore, the drawings are not to scale. The magnification factors shown may be less than would be used in an actual system, especially for a dense mapped network graph.

In FIG. 5A, an axis 504 represents a specified location on the density map in a two-dimensional plane 502. FIG. 5A shows a visualization lens 506. The top surface of the visualization lens 506 defines an area 508 on the plane 502 that is imaged by the lens. As shown, point V″ in the area 508 is immediately below point V′ viewed through the visualizations lens 506. Due to the magnification effect of the lens, however, point V″ is imaged as point V in an area 510. Thus, due to the effect of the visualization lens 506, the area 508 is displayed with a size equivalent to that of the area 510.

The modification of the parameters of the visualization lens is illustrated by FIGS. 5B-5C. FIG. 5B shows a visualization lens 520 having a size that is smaller than that of the visualization lens 506 shown in FIG. 5A. Because the visualization lens 520 has a smaller radius, a smaller sub-graph 522 of the mapped network graph is magnified. The magnification may produce a displayed sub-graph 524 that has the same size as the area 510 in FIG. 5A. Thus, fewer nodes and edges may be displayed using the visualization lens 520 shown in FIG. 5B than would be displayed by the larger visualization lens 506 shown in FIG. 5A. Because fewer nodes are displayed, the visualization lens 520 may display more information (e.g., node parameters) about each node than could be displayed by the visualization lens 506.

FIG. 5C shows how a modification of the shape of the lens may modify the displayed sub-graph. In FIG. 5C, the height of a visualization lens 530 is reduced relative to the visualization lens 506, without changing the radius of the lens. Thus, a sub-graph 532 of the mapped network graph is the same, but the size of a displayed sub-graph 534 is larger than the size of the area 510. When this lens parameter is modified, the size of the inset or overlay used by the user device 202 to display the sub-graph may be increased. For example, the circle of the visualization lens 160 in FIG. 1B may be larger. This may allow more information about the nodes in the specified sub-graph to be displayed.

FIG. 5D shows the effect of translating a user-specified pointer 540 across a two-dimensional plane 542. As shown, the translation of the pointer, corresponding to the axis 540, results in the display of a different sub-graph 544 of the mapped network graph as a magnified sub-graph 546.

FIG. 6 is a block diagram of example processing circuitry for clients, servers, and cloud-based processing system resources for implementing algorithms and performing methods according to example embodiments. The distributed processing system may include multiple instances of the circuitry shown in FIG. 6, which may be used to implement any of the processing circuitry shown in FIG. 2 to perform the algorithms represented by the flow-charts shown in FIGS. 3 and 4. All components need not be used in various embodiments. For example, each of the clients, servers, and network resources of the distributed processing system may use a different set of components, or in the case of the graph database server 220, for example, larger storage devices.

One example processing system, in the form of a computer 600, may include a processing unit 602, memory 603, removable storage 610, and non-removable storage 612 all coupled to a bus 601. The processing unit 602 may include one or more single-core or multi-core processing devices. Although the example processing system is illustrated and described as the computer 600, the processing system may be in different forms in different embodiments. For example, the processing system for the user device 202 may instead be a laptop, a tablet, or another processing device including elements the same as or similar to those illustrated and described with regard to FIG. 6. Devices such as laptops and tablets may be collectively referred to as mobile devices or user equipment. Further, although the various data storage elements are illustrated as part of the computer 600, the storage may also or alternatively include network-connected (e.g., cloud-based) storage accessible via a network, such as a local area network (LAN), a personal area network (PAN), a wide area network (WAN) such as the Internet, or local server-based storage.

The memory 603 may include volatile memory 614 and non-volatile memory 608. The computer 600 may include—or have access to a processing environment that includes—a variety of computer-readable media, such as the volatile memory 614 and non-volatile memory 608, the removable storage 610, and the non-removable storage 612. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

The computer 600 may include or have access to a processing environment that includes an input interface 606, an output interface 604, and a communication connection or interface 616, shown as connected to the bus 601. The output interface 604 may include a display device, such as a touchscreen or computer monitor, that also may serve as an input device coupled to the input interface 606. The input interface 606 may include one or more of a touchscreen, touchpad, mouse, keyboard, camera, one or more device-specific buttons, one or more sensors integrated within or coupled via wired or wireless data connections to the computer 600, and other input devices. The computer 600 may operate in a networked environment using a communication connection to connect to one or more remote computers, such as mainframes, servers, and/or database servers which may be used to implement the network-connected service 204. The user device 202 may include a personal computer (PC), server, router, network PC, peer device or other common network node, or the like. The communication connection may include a local area network (LAN), a wide area network (WAN), a cellular network, a Wi-Fi network, a Bluetooth network, the Internet, or other networks.

Computer-readable instructions stored on a computer-readable medium are executable by the processing unit 602 of the computer 600. A hard drive, CD-ROM, and RAM are some examples of articles including a non-transitory computer-readable medium such as magnetic storage media, optical storage media, flash media and solid state storage media. The terms “computer-readable medium” and “storage device” do not include carrier waves to the extent that carrier waves are deemed too transitory. For example, one or more applications 618 may be used to cause the processing unit 602 to perform one or more methods or algorithms described herein.

It should be understood that software can be installed in and sold with the user device 202 and/or one or more processors of the network-connected service 204. Alternatively the software can be obtained and loaded into the user device and/or one or more processors of the network-connected service 204, including obtaining the software through physical medium or distribution system, including, for example, from a server owned by the software creator or from a server not owned but used by the software creator. The software can be stored on a server for distribution over the Internet, for example.

The functions or algorithms described herein may be implemented using software, in one embodiment. The software may consist of computer-executable instructions stored on computer-readable media or a computer-readable storage device such as one or more physical memory devices or other types of hardware-based storage devices, either local or networked. Further, such functions correspond to modules, which may be software, hardware, firmware, or any combination thereof. Multiple functions may be performed in one or more modules as desired, and the embodiments described are merely examples. The software may be executed on a processing system such as a digital signal processor, application-specific integrated circuit (ASIC), microprocessor, mainframe processor, or other type of processor operating on a computer system, such as a personal computer, server, or other processing system, turning such a processing system into a specifically programmed machine.

What is claimed is:

1. A network graph analysis device comprising:
a memory storage including instructions; and
one or more processors in communication with the memory, wherein the one or more processors execute the instructions to:
identify clusters of nodes in a graph of a network based on edges connecting the nodes;
distribute the clusters of nodes in a two-dimensional plane to generate a two-dimensional representation of the network;
for each cluster:
distribute the nodes in the cluster in the two-dimensional plane;
calculate respective coordinates of the nodes in the cluster to generate a two-dimensional map of the cluster; and
store the calculated coordinates in the network graph to generate a mapped network graph;
generate a density map representation of the network based on the calculated coordinates of the nodes in the mapped network graph; and
in response to a selection of a sub-area of the density map representation, provide, for display, a selected sub-area including selected nodes and the edges connecting the selected nodes in the mapped network graph having coordinates corresponding to the selected sub-area of the density map representation.

2. The device of claim 1, wherein the one or more processors execute the instructions to:
provide the selected nodes and edges from the mapped network graph as a magnified image representing a magnification of the selected sub-area of the density map representation.

3. The device of claim 1, wherein the one or more processors execute the instructions to:
provide the density map representation to a user device;
receive, as the selection of the sub-area of the density map representation, a selected coordinate location in the density map representation; and
determine the selected nodes and edges to be displayed based on the selected coordinate location.

4. The device of claim 3, wherein the one or more processors execute the instructions to:
receive a lens shape parameter and a lens size parameter;
determine the selected nodes and edges to be displayed based on the selected coordinate location and the lens size parameter; and
determine a layout of the selected nodes and edges based on the lens shape parameter.

5. The device of claim 1, wherein the one or more processors execute the instructions to:
assign force-directed graph distribution parameters to each cluster and to each edge connecting the cluster to another one of the clusters; and
apply force-directed graph distribution to the clusters to define respective coordinate positions of respective centroids for the clusters in the two-dimensional plane.

6. The device of claim 1, wherein the one or more processors execute the instructions to:
determine an updated centroid for each cluster based on the calculated coordinates of the nodes in the cluster; and
update the coordinates of the nodes in the cluster in response to the updated centroid for the cluster.

7. The device of claim 1, wherein the one or more processors execute the instructions to:
implement a plurality of parallel processing threads; and
calculate the coordinates of the nodes in each of the clusters using a respectively different parallel processing thread.

8. The device of claim 7, wherein the one or more processors that execute the instructions to calculate the coordinates of the nodes in each of the clusters using a respectively different parallel processing thread include one or more processors implementing each of the parallel processing threads that execute the instructions to:
assign force-directed graph parameters to each node and each edge in the cluster; and
apply force-directed graphing to the nodes and edges in the cluster to define a layout of the nodes in the cluster in the two-dimensional plane.

9. A method for analyzing a graph of a network, the method comprising:
identifying, by one or more processors, clusters of nodes in the network graph based on edges connecting the nodes;
distributing, by the one or more processors, the clusters of nodes in a two-dimensional plane to generate a two-dimensional representation of the network;
for each cluster:
calculating, by the one or more processors, respective coordinates of the nodes in the cluster to generate a two-dimensional map of the cluster; and
storing, in a memory, the calculated coordinates in the network graph to generate a mapped network graph;
generating, by the one or more processors, a density map representation of the network based on the calculated coordinates of the nodes in the mapped network graph; and
in response to a selection of a sub-area of the density map representation, providing for display, by one or more processors, selected nodes and the edges connecting the selected nodes in the mapped network graph, the selected nodes having coordinates in the mapped network graph corresponding to the selected sub-area of the density map representation.

10. The method of claim 9, wherein providing the selected nodes for display includes providing the selected nodes and edges from the mapped network graph as a magnified image representing a magnification of the selected sub-area of the density map representation.

11. The method of claim 9, further comprising:
providing, by the one or more processors, the density map representation to a user device;
receiving, by the one or more processors, as the selected sub-area of the density map representation, a selected coordinate location in the density map representation; and
determining, by the one or more processors, the selected nodes and edges to be displayed based on the selected coordinate location.

12. The method of claim 11, further comprising:
receiving, by the one or more processors, a lens shape parameter and a lens size parameter;
determining, by the one or more processors, the selected nodes and edges to be displayed based on the selected coordinate location and the lens size parameter; and
determining, by the one or more processors, a layout of the selected nodes and edges based on the lens shape parameter.

13. The method of claim 9, wherein distributing the clusters of nodes includes:
assigning, by the one or more processors, force-directed graph distribution parameters to each cluster and to each edge connecting the cluster to another one of the clusters; and
applying, by the one or more processors, force-directed graph distribution to the clusters to define respective coordinate positions of respective centroids for the clusters in the two-dimensional plane.

14. The method of claim 9, wherein calculating the coordinates of each node for each cluster includes:
determining, by the one or more processors, an updated centroid for each cluster based on the calculated coordinates of the nodes in the cluster; and
updating, by the one or more processors, the coordinates of the nodes in the cluster in response to the updated centroid for the cluster.

15. The method of claim 9, wherein calculating the coordinates of the nodes comprises:
implementing, by the one or more processors, a plurality of parallel processing threads; and
calculating, by the one or more processors, the coordinates of the nodes in each of the clusters using a respectively different parallel processing thread.

16. The method of claim 15, wherein calculating the coordinates of the nodes of a respective cluster using a respectively different parallel processing thread includes:
assigning, by the one or more processors, force-directed graph parameters to each node and each edge in the cluster; and
applying, by the one or more processors, force-directed graphing to the nodes and edges in the cluster to define a layout of the nodes in the cluster in the two-dimensional plane.

17. A non-transitory computer-readable medium storing computer instructions for analyzing a network graph, that, when executed by one or more processors, cause the one or more processors to perform the steps of:
identifying clusters of nodes in the network graph based on edges connecting the nodes;
distributing the clusters of nodes in a two-dimensional plane to generate a two-dimensional representation of the network;
for each cluster:
calculating respective coordinates of the nodes in the cluster to generate a two-dimensional map of the cluster; and
storing the calculated coordinates in the network graph to generate a mapped network graph;
generating a density map representation of the network based on the calculated coordinates of the nodes in the mapped network graph; and
in response to a selection of a sub-area of the density map representation, providing for display selected nodes and the edges connecting the selected nodes in the mapped network graph, the selected nodes having coordinates in the mapped network graph corresponding to the selected sub-area of the density map representation.

18. The non-transitory computer-readable medium of claim 17, wherein the computer instructions, when executed by the one or more processors, cause the one or more processors to perform the steps of:
providing the density map representation to a user device;
receiving, as the selected sub-area of the density map representation, a selected coordinate location in the density map representation; and
determining the selected nodes and edges to be displayed based on the selected coordinate location.

19. The non-transitory computer-readable medium of claim 18 wherein the computer instructions, when executed by the one or more processors, cause the one or more processors to perform the steps of:
receiving a lens shape parameter and a lens size parameter;
determining the selected nodes and edges to be displayed based on the selected coordinate location and the lens size parameter; and
determining a layout of the selected nodes and edges based on the lens shape parameter.

20. The non-transitory computer-readable medium of claim 17, wherein the computer instructions, when executed by the one or more processors, cause the one or more processors to perform the steps of:
implementing a plurality of parallel processing threads; and
calculating the coordinates of the nodes in each of the clusters using a respectively different parallel processing thread.
